(19) United States
(12) Patent Application Publication
(10) Pub. No.: US 2011/0074054 A1
(43) Pub. Date: Mar. 31, 2011

(54) PROCESS FOR PRODUCING AN OPTICAL WAVEGUIDE AND STAMP FOR USE IN THE PRODUCTION PROCESS

(76) Inventors: Kozo Tajiri, Sanda-Shi (JP); Tomomi Makino, Ashiya-shi (JP)

(21) Appl. No.: 12/996,098

(22) PCT Filed: Jun. 1, 2009
(86) PCT No.: PCT/JP2009/059956

§ 371 Date: Dec. 3, 2010

(30) Foreign Application Priority Data
Jun. 4, 2008 (JP) 2008-147315

(51) Int. Cl. G02B 6/13; B28B 11/10

(52) U.S. Cl. 264/1.28; 425/396

(57) ABSTRACT

In an optical waveguide, the present invention provides a process for producing an optical waveguide, and a stamp for use in the production process, in which the thickness of a lower cladding layer in the portion positioned in the lower side of a core layer is easily controlled even if any one or more materials of a substrate, a cladding material, and a stamp are material with low rigidity. The production process of the present invention comprises steps of forming a lower cladding layer which has a core groove and spacer grooves formed substantially in parallel with intervals in both sides of the core groove on a substrate by making use of soft lithography with a second stamp (i.e., a male stamp); then forming a core layer by injecting and filling a core material into the core groove, followed by curing the core material; further forming a upper cladding layer by injecting and filling a cladding material into the spacer grooves and applying the cladding material to the lower cladding layer so as to be embedded the core layer and followed by curing. A stamp used in the production process of the present invention comprises a convex portion or a concave portion corresponding to a core groove and convex portions or concave portions corresponding to spacer grooves formed substantially in parallel with intervals in both sides of the convex portion or the concave portion corresponding to the core groove.

### TECHNICAL FIELD

The present invention relates to a process for producing an optical waveguide and a stamp for use in the production process.

### BACKGROUND ART

Along with the practical applications of optical transmission systems, techniques relevant to optical waveguides as their basic components have drawn much attention. An optical waveguide has, typically, an embedded type structure in which a core layer having a high refractive index is surrounded with a cladding layer having a low refractive index, or a ridge type structure in which a core layer having a high refractive index is formed on a lower cladding layer having a low refractive index and an upper cladding layer is an air layer. Thus, light incoming to the optical waveguide is transmitted in the core layer while being reflected at the interface between the core layer and the cladding layers or at the interface between the core layer and the air layer.

As an optical waveguide production process, for example, a method is employed involving forming a lower cladding layer by applying a cladding material to a substrate and curing the cladding material; subsequently forming a core layer either by applying a core material to the lower cladding layer, curing the core material after putting a mask thereon, and removing uncured portions or by applying a core material to the lower cladding layer, curing the core material, then forming a patterned resist layer, and removing uncovered portions; and thereafter forming an upper cladding layer by applying a cladding material to the lower cladding layer in a manner of embedding the core layer therein and curing the cladding material.

For this method, recently, it has been discussed to employ a stamper method as a method for simply and economically manufacturing an optical waveguide. For example, Patent Documents 1, 2 and 3 disclose methods involving dropping a cladding material to a glass substrate, pressing a stamp having the same pattern as that of a core layer in the surface to form a core groove, and then curing the cladding material to form a lower cladding layer having the core groove, thereafter injecting and filling a core material into the core groove, curing the core material to form a core layer, and then dropping the cladding material to the lower cladding layer in a manner of embedding the core layer therein, adhering a base substrate, and curing the clad material to form an upper cladding layer.

In these stamper methods, since a glass substrate with high rigidity is employed at the time of forming the lower cladding layer having the core groove, even if the cladding material is dropped to the glass substrate, and then the stamp having the same pattern as that of a core layer in the surface is pressed to the glass substrate, the glass substrate does not slack and a lower cladding layer having a substantially uniform thickness in the portion positioned in the lower side of the core layer is formed. If the lower cladding layer has a substantially uniform thickness in the portion positioned in the lower side of the core layer, light can be transmitted in the core layer of the obtained optical waveguide with low loss and thus the light transmission efficiency can be improved.

However, since employing a glass substrate, the above-mentioned conventional stamper methods are limited to a batch type process of manufacturing optical waveguides one by one and are inferior in the efficiency of manufacturing optical waveguides. Therefore, in order to improve the efficiency of manufacturing optical waveguides, it is required to employ a continuous process of continuously manufacturing optical waveguides by preparing a roll of a film substrate and subsequently forming a lower cladding layer, a core layer, and an upper cladding layer on the film substrate while drawing out the film substrate from the roll. Further, in the case of manufacturing an opto-electronic hybrid integrated module from an optical waveguide, since light passes a substrate, it is preferable to use a film substrate which is thin in the thickness as compared with a glass substrate and therefore which has the short length of the path of light and a refractive index close to that of an optical waveguide film and thus less reflects light, in consideration of light transmitting efficiency.
Patent Document 1: Japanese Patent Laid-open Publication (Kokai) No. 2006-227655
Patent Document 2: Japanese Patent Publication No. 3858989
Patent Document 3: Japanese Patent Publication No. 3858995

### DISCLOSURE OF THE INVENTION

### Problems to be Solved by the Invention

However, since having low rigidity as compared with a glass substrate, a film substrate slacks in a case where a cladding material is dropped to the film substrate and a stamp having the same pattern as that of a core layer in the surface is pressed to the film substrate and accordingly it results in a problem that it becomes impossible to form a lower cladding layer with a substantially uniform thickness in the portion positioned in the lower side of the core layer.

Further, similarly, also in a case where the stamp is made of a flexible material, when the stamp is pressed to the substrate surface to which the cladding material is dropped, the stamp slacks and accordingly it results in a problem that it becomes difficult to form a lower cladding layer with a uniform thickness. Further, in a case where any one of the substrate, the cladding material, and the stamp has low rigidity, it becomes difficult to make the thickness of the lower cladding layer uniform and to obtain an optical waveguide with low wave guide loss.

Under the above-mentioned circumstances, with respect to an optical waveguide, an object to be solved by the present invention is to provide a process for producing an optical waveguide in which the thickness of a lower cladding layer is easily controlled in the portion positioned in the lower side of a core layer even if any one or more materials of a substrate, a cladding material, and a stamp are material with low rigidity, and a stamp for use in the production process.

### Means for Solving the Problems

The present inventors have made various investigations and as a result, they have found that if not a male stamp having only a convex portion corresponding to a core groove, but a male stamp having a convex portion corresponding to a core groove and convex portions corresponding to spacer grooves formed substantially in parallel with intervals in both sides of the convex portion corresponding to the core groove is employed to form a lower cladding layer having a core groove and spacer grooves formed substantially in parallel with intervals in both sides of the core groove on a substrate, due to the existence of the convex portions (spacers) corresponding to the spacer grooves, the substrate or the male stamp is supported and held substantially in parallel without slacking and thus the thickness of the lower cladding layer can be easily controlled in the portion positioned in the lower side of the core layer, thereby completing the present invention.

That is, the present invention provides a process for producing an optical waveguide which comprises steps of: forming a lower cladding layer having a core groove and spacer grooves formed substantially in parallel with intervals in both sides of the core groove on a substrate by using a second stamp having a convex portion corresponding to the core groove and convex portions corresponding to spacer grooves formed substantially in parallel with intervals in both sides of the convex portion corresponding to the core groove; forming a core layer by injecting and filling a core material into the core groove and followed by curing the core material; and forming an upper cladding layer by injecting and filling a cladding material into the spacer grooves and applying the cladding material to the lower cladding layer in a manner of embedding the core layer therein and followed by curing the cladding material.

The step of forming the lower cladding layer preferably includes a step of dropping a cladding material to the substrate, placing the second stamp having the convex portion corresponding to the core grove and the convex portions corresponding to the spacer grooves formed substantially in parallel with intervals in both sides of the convex portion corresponding to the core groove on the substrate, curing the clad material, and removing the second stamp to form the lower cladding layer having the core groove and the spacer grooves formed substantially in parallel with intervals in both sides of the core groove on the substrate.

In the production process of the present invention, a film substrate is preferable as the substrate. A ratio of (y/x) of the depth (y) of the spacer groove to the interval (x) between the core groove and the spacer grove is 1/10 or higher and 3/1 or lower. Further, the cladding material is preferably cured after dropping the cladding material and placing the second stamp on the substrate, pushing the second stamp against the substrate to closely contact the convex portions corresponding to the spacer grooves. In this regard, the second stamp may be prepared by using a first stamp having a concave portion corresponding to the core groove and concave portions corresponding to the spacer grooves. Furthermore, the cladding material and/or the core material preferably is a UV-curable type epoxy resin.

Further, the present invention provides a stamp employed in the above-mentioned production process of the optical waveguide, wherein the stamp comprises a convex portion or a concave portion corresponding to a core groove and convex portions or concave portions corresponding to spacer grooves formed substantially in parallel with intervals in both sides of the convex portion or the concave portion corresponding to the core groove

In the stamp employed in the production process of the optical waveguide of the present invention, a ratio (y/x) of the depth (y) of the concave portion corresponding to the spacer groove to the interval (x) between the concave portion corresponding to the core groove and the concave portion corresponding to spacer grove or a ratio (y/x) of the height (y) of the convex portion corresponding to the spacer groove to the interval (x) between the convex portion corresponding to the core groove and the convex portion corresponding to spacer grove are 1/10 or higher and 3/1 or lower.

### Advantageous Effect of the Invention

In the process for producing the optical waveguide of the present invention, since a second stamp (a male stamp) having a convex portion corresponding to a core groove and convex portions corresponding to spacer grooves formed substantially in parallel with intervals in both sides of the convex portion corresponding to the core groove is employed to form a lower cladding layer having a core groove and spacer grooves formed substantially in parallel with intervals in both sides of the core groove on a substrate, even if a substrate with low rigidity such as a film substrate is used, or a cladding material or a stamp having a convex portion corresponding to a core groove, which are both made of a material with low rigidity, is used, an optical waveguide having a substantially uniform thickness of a lower cladding layer in the portion positioned in the lower side of a core layer and having extremely low waveguide loss can be manufactured easily.

Further, an optical waveguide can be produced just like intaglio printing on a large scale by, while continuously drawing out a film substrate in the form of a roll and allowing the film substrate to run, bringing the film substrate into contact with a roll having a second stamp attached thereon to form a lower cladding layer and then successively forming a core layer and an upper cladding layer thereon.

Further, with respect to the resultant optical waveguide, since the lower cladding layer, the core layer, and the upper cladding layer are formed on the film substrate, if a film substrate with an electric wiring is used as the substrate, an opto-electronic hybrid integrated module can be produced in a simple and easy manner by cutting a portion(s), on which a light emitting element(s) and/or a light receiving element(s) are/is to be mounted, with a dicing saw into “V” shape to form a 45° mirror(s).

### BRIEF DESCRIPTION OF THE DRAWINGS

FIG. 1 is a schematic step drawing for explaining a typical example of a process for producing an optical waveguide according to the present invention.

### BEST MODE FOR CARRYING OUT THE INVENTION

### <Process for Producing an Optical Waveguide>

The process for producing the optical waveguide of the present invention (hereinafter, sometimes referred to as “production process of the present invention”) comprises steps of: forming a lower cladding layer having a core groove and spacer grooves formed substantially in parallel with intervals in both sides of the core groove on a substrate by either dropping a cladding material and placing a second stamp having a convex portion corresponding to the core groove and convex portions corresponding to the spacer grooves formed in parallel with intervals in both sides of the convex portion corresponding to the core groove on the substrate, or placing a second stamp having a convex portion corresponding to the core groove and convex portions corresponding to the spacer grooves formed in parallel with intervals in both sides of the convex portion corresponding to the core groove on the substrate and injecting and filling a cladding material between the substrate and the second stamp, thereafter curing the cladding material and removing the second stamp; forming a core layer by injecting and filling a core material into the core groove and curing the core material; and forming an upper cladding layer by injecting and filling a cladding material into the spacer grooves and applying the cladding material to the lower cladding layer in a manner of embedding the core layer therein and thereafter curing the cladding material.

The production process of the present invention is a process comprising forming a lower cladding layer having a core groove and spacer grooves formed substantially in parallel with intervals in both sides of the core groove on a substrate by making use of soft lithography with a second stamp (i.e., a male stamp) which has a convex portion corresponding to the core groove and convex portions corresponding to the spacer grooves formed in parallel with intervals in both sides of the convex portion corresponding to the core groove. The soft lithography is one of the stamper methods and is a method of transferring a lower cladding layer with a second stamp (i.e., a male stamp) formed from a soft material such as a silicone type rubber or an urethane type rubber.

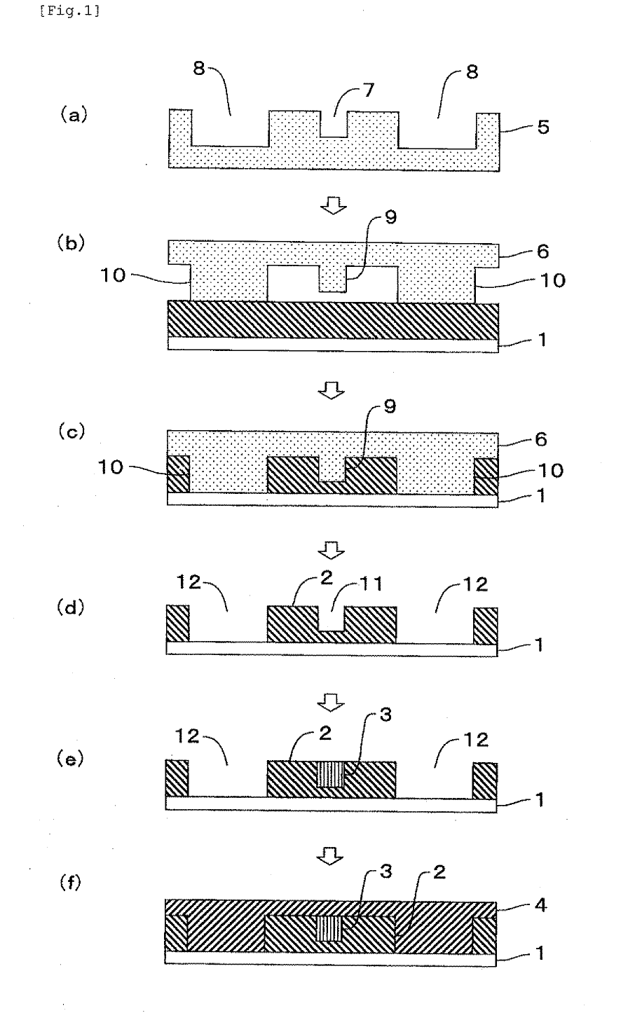

Referring to FIG. 1, a typical example of the production process of the present invention will be described below in detail; however, the production process of the present invention is not limited to the following typical example, and can be carried out with its appropriate modification or variation.

First, as shown in FIG. 1(a), for example, a metal or an alloy such as phosphor bronze is cut to form a concave portion 7 corresponding to a core groove, and concave portions 8 corresponding to spacer grooves formed in parallel with intervals in both sides of the concave portion corresponding to the core groove, to thereby produce a first stamp (i.e., a female stamp) 5.

Next, for example, the two-component type curable silicone material is applied on the first stamp 5 and then cured, and the first stamp 5 is then removed, to thereby produce a second stamp (i.e., a male stamp) 6 having a convex portion 9 corresponding to the core groove, and convex portions (spacers) 10 corresponding to the spacer grooves formed in parallel with intervals in both sides of the convex portion corresponding to the core groove, as shown in FIG. 1(b).

When the second stamp 6 is produced, for the purpose of easily separating the second stamp 6 from the first stamp 5, a release agent may be applied to the first stamp 5. As the release agent, any of the heretofore known release agents may be used, and it is not particularly limited.

Next, as shown in FIG. 1(b), for example, after a proper amount of a cladding material is dropped to a substrate 1 made of a polyimide film or the like, the second stamp 6 is set close in a manner of bringing the convex portions (spacers) 10 corresponding to the spacer grooves into contact with the substrate 1, for example, on a stage provided with parallelism. At this time, it is preferable to once stop the second stamp 6 and to carry out defoaming by vacuum evacuation to remove foams from the cladding material before the convex portions (spacers) 10 corresponding to the spacer grooves of the second stamp 6 are brought into contact with the substrate 1. Alternatively, after the second stamp 6 is placed on the substrate in a manner of bringing convex portions (spacers) 10 corresponding to the spacer grooves into contact with the substrate 1, the cladding material may be injected and filled into a space between the substrate 1 and the second stamp 6. In both cases, it is preferable that the second stamp 6 is pushed against the substrate 1 and, as shown in FIG. 1(c), the convex portions (spacers) 10 corresponding to the spacer grooves are closely contacted to the substrate 1.

Regardless of inorganic materials and organic materials, any of known materials can be used as the substrate 1 and it is preferable to use, for example, a silicon substrate; a glass substrate made of quartz, Pyrex (registered trade name), or the like; a metal substrate made of Al, Cu, or the like; a metal oxide substrate; a resin substrate made of polyimide, polyether ketone, or the like; an organic-inorganic hybrid substrate, etc. Particularly, the resin substrate is preferable and a film substrate made of a resin film is more preferable.

As the film substrate, a resin film made of any of known optical waveguide material can be used, and it is not particularly limited. Examples of the resin films include epoxy type resins, polyimide type resins, acrylic type resins, polyester type resins, polystyrene type resins, cycloolefin type resins, polyether sulfone type resins, polyether ketone type resins, polyether nitrile type resins, oxetane type resins, silane type resins, and silicone type resins. Among them, taking into consideration the production of an opto-electronic hybrid integrated module, from the viewpoint of heat resistance (in particular, heat resistance assuming soldering, specifically heat resistance to temperatures of from 200° C. to 250° C.), films made of polyimide type resins, i.e., polyimide films (including halogenated polyimide films) may be preferred. When polyimide films are used as film substrates, their commercially available products may be used. Examples of polyimide films may include “Kapton (registered trade name)” series, available from Du Pont-Toray Co., Ltd.

The thickness of the substrate 1 may appropriately be selected depending on the applications of the optical waveguide and the wavelength of light to be used when the opto-electronic hybrid integrated flexible module is produced, and other factors, and it is not particularly limited; however, it may preferably be 5 μm or greater, more preferably 10 μm or greater, and preferably 100 μm or smaller, more preferably 50 μm or smaller. If the thickness of the substrate 1 is too small, the strength of the substrate may be lowered. In contrast, if the thickness of the substrate is too great, the transparency of the substrate may be lowered when an opto-electronic hybrid integrated module is produced.

In the production process of the present invention, since, in addition to the convex portion 9 corresponding to the core groove, the convex portions (spacers) 10 corresponding to the spacer grooves formed in parallel with intervals in both sides of the convex portion corresponding to the core groove are formed in the second stamp 6, even if a substrate with low rigidity such as a film substrate is used, the substrate 1 or the second stamp 6 does not slack when the second stamp 6 is placed on the substrate 1 and thus the interval between the convex portion 9 corresponding to the core groove and the substrate 1 can be kept substantially uniform. Moreover, it is made easy to control the thickness of a lower cladding layer 2 in the portion positioned in the lower side of the core layer by properly setting the depth of the spacer groove, that is, the height of the convex portion (spacer) 10 corresponding to the spacer groove.

After the cladding material filled into the space between the substrate 1 and the second stamp 6 is cured, the second stamp 6 is removed to form, as shown in FIG. 1(d), the lower cladding layer 2 having a core groove 11 and spacer grooves 12 formed substantially in parallel with intervals in both sides of the core groove 11 on the substrate 1. A cladding material constituting the lower cladding layer 2 may be any of the heretofore known optical waveguide materials, and it is not particularly limited. Examples thereof may include hardening resins such as UV-curable (or light-curable) resins and thermo-setting resins, and thermoplastic resins. In these resins, UV-curable (or light-curable) resins may be preferred.

In the lower cladding layer 2, a ratio (y/x) of the depth (y) of the spacer groove 12 to the interval (x) between the core groove 11 and the spacer grove 12 is preferably 1/10 or higher, more preferably ⅛ or higher, and even more preferably 1/7 or higher and preferably 3/1 or lower, more preferably 2/1 or lower, and even more preferably 3/2 or lower. If the ratio (y/x) is too low, since the interval between the core groove 11 and the spacer groove 12 is too wide in a case where a core layer with a sufficient thickness is to be formed, many unnecessary portions of the lower cladding layer 2 are formed in both sides of the core layer and it may sometimes increase the production cost. Further, in the second stamp 6, the interval between the convex portion 9 corresponding to the core groove 11 and the convex portion 10 corresponding to the spacer groove 12 becomes wide and in a case where the second stamp 6 is placed on the substrate 1, the second stamp 6 tends to slack and thus the thickness of the lower cladding layer 2 positioned in the lower side of the core layer cannot be made substantially uniform in some cases. On the other hand, if the ratio (y/x) is too high, although a core layer with a sufficient thickness can be formed, the thickness of the lower cladding layer 2 positioned in the lower side of the core layer becomes thick and also the production cost may be increased in some cases.

In the lower cladding layer 2, the depth of the spacer groove 12 is set to be substantially the same as the thickness of the lower cladding layer 2. The width of the spacer groove 12 may be properly adjusted corresponding to the thickness of the lower cladding layer 2 and is not particularly limited; however in a case where the depth of the spacer groove 12 is assumed to be 1, the width thereof is preferably 2 or higher, more preferably 5 or higher, and even more preferably 10 or higher and preferably 50 or lower, more preferably 30 or lower, and even more preferably 20 or lower. If the width of the spacer groove 12 is too small to the depth of the spacer groove 12, since the width of the convex portion (spacer) 10 corresponding to the spacer groove 12 in the second stamp 6 becomes narrow, the substrate 1 or the second stamp 6 may sometimes slack when the second stamp 6 is pushed against the substrate 1. On the other hand, if the width of the spacer grooves 12 is too wide to the depth of the spacer groove 12, since the width of the convex portion (spacer) 10 corresponding to the spacer groove 12 in the second stamp 6 becomes wide, the amount of materials constituting the second stamp 6 or the cladding material to be injected and filled into the spacer grooves 12 of the lower cladding layer 2 is unnecessarily increased and thus the production cost may be increased in some cases.

The thickness of the lower cladding layer 2 may appropriately be selected depending on the applications of the optical waveguide, the wavelength of light to be used, and other factors, and it is not particularly limited; however, it may preferably be 10 μm or greater, and more preferably 20 μm or greater, and preferably 150 μm or smaller, more preferably 100 μm or smaller, excluding the lower side of the core groove 11. If the thickness of the lower cladding layer 2 is too small, a core layer 3 having a sufficient thickness may be difficult to be formed. In contrast, if the thickness of the lower cladding layer 2 is too great, the transparency of the lower cladding layer 2 maybe lowered when an opto-electronic hybrid integrated module is produced.

The refractive index of the lower cladding layer 2 is not particularly limited so long as it is lower than that of the core layer 3; however, it may arbitrarily be adjusted, for example, in a range of from 1.45 to 1.65 by selecting the kind of a cladding material and a composition thereof.

In addition, in a case where the second stamp 6 is made of silicone type rubber and the lower cladding layer 2 is formed using a thermosetting resin, a thermoplastic resin, or an ultraviolet (or light) curable resin, if the lower cladding layer 2 is formed several ten times using the second stamp 6, the second stamp 6 may sometimes be deteriorated due to heat and change with the lapse of time. Further, after the lower cladding layer 2 is formed, contamination will be caused due to the residues of the cladding material. In these cases, the second stamp 6 may be produced again from the first stamp 5 and used.

Next, as shown in FIG. 1(e), a core material is injected and filled into the core groove 11 and the core material is cured to form the core layer 3. In this connection, in FIG. 1(e), only one core layer 3 is formed; however two or more core layers may be formed according to the applications of the optical waveguide. Furthermore, the core layer 3 is formed in a line extending along the perpendicular direction to the paper face; however it may be formed in a prescribed pattern depending on the applications of the optical waveguide. A core material constituting the core layer 3 maybe any of the heretofore known optical waveguide materials, and it is not particularly limited so long as it has a refractive index higher than that of a cladding material constituting the lower cladding layer 2 and that of a cladding material constituting the upper cladding layer 4. Examples thereof may include hardening resins such as UV-curable (or light-curable) resins and thermo-setting resins. In these resins, UV-curable (or light-curable) resins may be preferred.

The thickness of the core layer 3 may arbitrarily be set depending on the applications of the optical waveguide and the wavelength of light to be used, and other factors, and it is not particularly limited; however, it may preferably be 5 μm or greater, and more preferably 10 μm or greater, and preferably 100 μm or smaller, more preferably 50 μm or smaller. If the thickness of the core layer 3 is too thin, the quantity of light to be transmitted in the core layer 3 may sometimes be lowered. On the other hand, if the thickness of the core layer 3 is too thick, the thickness of the lower cladding layer 2 is required to be made thick and many unnecessary portions of the lower cladding layer 2 are formed in both sides of the core layer 3 and the production cost may sometimes be increased. Further, since the thicknesses of the lower cladding layer 2 and the core layer 3 constituting the optical waveguide become thick, the thickness of the optical waveguide to be formed on the substrate 1 may sometimes become thick.

The core layer 3 may preferably have a rectangular, most preferably square, shape in the cross section perpendicular to the longitudinal direction. That is, the aspect ratio (width/thickness) of the core layer 3 may preferably be ½ or higher, more preferably ⅔ or higher, and still more preferably ⅚ or higher, and preferably 2/1 or lower, more preferably 3/2 or lower, and still more preferably 6/5 or lower. It may most preferably be 1/1. If the aspect ratio of the core layer 3 is too low or too high, the shape of the cross section perpendicular to the longitudinal direction of the core layer 3 becomes flat, so that when light comes in the core layer 3 or light comes out the core layer 3, light loss may be caused.

The refractive index of the core layer 3 is not particularly limited so long as it is higher than that of the lower cladding layer 2 and that of the upper cladding layer 4; however, it may arbitrarily be adjusted, for example, in a range of from 1.45 to 1.65 by selecting the kind of a core material and the composition thereof.

Next, as shown in FIG. 1(f), after the cladding material is injected and filled into the spacer grooves 12 and the cladding material is so applied to the lower cladding layer 2 and the core layer 3 in a manner of embedding the core layer 3, the cladding material is then cured to form the upper cladding layer 4. A cladding material constituting the upper cladding layer 4 maybe the same as or different from the cladding material constituting the lower cladding layer 2, and it is not particularly limited. Examples thereof may include hardening resins such as UV-curable (or light-curable) resins and thermo-setting resins, and thermoplastic resins. In these resins, UV-curable (or light-curable) resins may be preferred.

The thickness of the upper cladding layer 4 may appropriately be selected depending on the applications of the optical waveguide and the wavelength of light to be used, and other factors, and it is not particularly limited; however, it may preferably be 10 μm or greater, more preferably 20 μm or greater, and preferably 100 μm or smaller, more preferably 50 μm or smaller. If the thickness of the upper cladding layer 4 is too small, the strength of the upper cladding layer 4 may be lowered. In contrast, the thickness of the upper cladding layer 4 is too large, many unnecessary portions are formed and it may sometimes increase the production cost.

The refractive index of the upper cladding layer 4 is not particularly limited so long as it is lower than that of the core layer 3; however, it may arbitrarily be adjusted, for example, in a range of from 1.45 to 1.65 by selecting the kind of a cladding material and the composition thereof.

Specific examples of the hardening resins and thermoplastic resins to be used in the present invention may include epoxy type resins, polyimide type resins, acrylic type resins, polystyrene type resins, cycloolefin type resins, polyether sulfone type resins, polyether ketone type resins, polyether nitrile type resins, oxetane type resins, silane type resins, and silicone type resins. These resins may be used alone, and two or more of these resins may also be used in combination. Further, these resins may be those of the solution type, which resins are dissolved in a solvent, or may be those of the solventless type, which resins contain no solvent; however, those of the solventless type may be preferred. Further, when these resins are used as hardening resins, a curing agent(s) and/or a crosslinking agent(s) may be used in combination.

In a case where a hardening resin with low viscosity is used among hardening resins such as an UV-curable (or light-curable) resin and a thermosetting resin as the cladding material and the core material, after a liquid-state hardening resin is filled into the space between the film substrate 1 and the second stamp 6 and also in the core groove 11 formed in the lower cladding layer 2 or after the liquid-state hardening resin is filled into the spacer grooves 12 formed in the lower cladding layer 2 and applied to the lower cladding layer 2, the liquid-state curable resin is cured by ultraviolet rays (or light) or heat to form the lower cladding layer 2, the core layer 3, and the upper cladding layer 4. Alternatively, in a case where a thermoplastic resin is used or a resin with high viscosity among hardening resins such as UV-curable (or light-curable) resins and thermosetting resins is used, after a resin made to be in fluidized state or melted state by heating is filled into the space between the film substrate 1 and the second stamp 6 and also in the core groove 11 formed in the lower cladding layer 2 or after the resin is filled into the spacer grooves 12 formed in the lower cladding layer 2 and applied to the lower cladding layer 2, the resin is cured by cooling in the case of the thermoplastic resin or by ultraviolet rays (or light) or heat in the case of the hardening resin to form the lower cladding layer 2, the core layer 3, and the upper cladding layer 4. In term of workability, the viscosity of each of the materials to be filled may preferably be 0.0001 Pa·s or higher, more preferably 0.001 Pa·s or higher, and preferably 100 Pa·s or lower, more preferably 50 Pa·s or lower. If the viscosity of each of the materials to be filled is too low, it takes a long time for curing, and therefore, workability may be lowered. In contrast, if the viscosity of each of the materials to be filled is too high, handling property may become deteriorated to lower workability or air may be entrapped to form some defects.

Thus, as shown in FIG. 1(f), the optical waveguide having the lower cladding layer 2 formed on the substrate 1, the core layer 3 formed in the core groove 11 which is formed on the lower cladding layer 2, the upper cladding layer 4 formed on the lower cladding layer 2 and the core layer 3 in a manner of embedding the core layer 3 therein, can be obtained.

In the foregoing, a process for producing only one optical waveguide with the master stamp (i.e., the first stamp 5) as shown in FIG. 1(a) is described; however, two or more optical waveguides can also be produced with a master stamp (i.e., a first stamp) corresponding to two or more optical waveguides. In this case, at the stage that the lower cladding layer 2 is formed on the film substrate 1, respective chips are cut by, for example, dicing, and thereafter, the respective optical waveguides may be produced in the same manner as described above.

According to the production process of the present invention, it is made easy to produce an optical waveguide having a controlled and substantially uniform thickness of the lower cladding layer 2 in the portion positioned in the lower side of the core layer 3 and having extremely low waveguide loss.

Further, an optical waveguide can be produced on a large scale just like intaglio printing by attaching the stamp (i.e., the second stamp 6) made of a resin as shown in FIG. 1(b) to the surface of a roll.

Further, the resultant optical waveguide has the lower cladding layer 2, the core layer 3, and the upper cladding layer 4, all of which are formed on the substrate 1, and therefore, if an electric wiring film substrate is used as the substrate 1, an opto-electronic hybrid integrated module can be produced in a simple and easy manner by cutting a portion(s), on which a light emitting element(s) and/or a light receiving element(s) are/is to be mounted, with a dicing saw into “V” shape to form a 45° mirror(s).

Further, in the production process of the present invention, if a concave portion corresponding to the optical fiber fixation groove is formed in series (in the direction perpendicular to the paper face) to the concave portion 7 corresponding to the core groove on the master stamp (i.e., the first stamp 5) as shown in FIG. 1(a), an optical waveguide substrate having an optical fiber fixation groove is obtained.

A weir is preferably provided between the optical fiber fixation groove and the core groove. The weir is formed of a cladding material constituting the lower cladding layer to have an appropriate thickness (i.e., an interval between the optical fiber fixation groove and the core groove), so that it does not cause any trouble for the communication of optical signals between the core of an optical fiber to be mounted in the optical fiber fixation groove and the core layer formed in the core groove.

The thickness of the weir may preferably be not smaller than 5 μm and not greater than 50 μm. If the thickness of the weir is too small, the weir may be unable to be clearly transferred when the lower cladding layer is formed with a second stamp (i.e., male stamp) having a concave portion corresponding to the weir. In contrast, if the thickness of the weir is too great, the transmission loss of optical signals between the core of an optical fiber to be mounted in the optical fiber fixation groove and the core layer formed in the core groove may become increased. The height of the weir (i.e., the height from the bottom face of the core groove) may appropriately be set depending on the outer diameter, core diameter, and other factors of an optical fiber to be mounted in the optical fiber fixation groove, and it is not particularly limited.

Further, it is preferable that the upper end face portion of the core groove is made lower than the upper end face portion of the optical fiber fixation groove. The difference between the upper end face portion of the optical fiber fixation groove and the upper end face portion of the core groove preferably corresponds to the thickness of the upper cladding layer.

### <UV-Curable Type Epoxy Resin>

As the cladding material and the core material to be used in the production process of the present invention, an epoxy type resin is preferable among the above-mentioned hardening resins and thermoplastic resins and a UV-curable type epoxy resin is more preferable and since a flexible optical waveguide can be obtained, a UV-curable type epoxy resin containing a polyglycidyl compound having a polyalkylene glycol chain and at least two glycidyl groups is particularly preferable.

In the polyglycidyl compound having a polyalkylene glycol chain and at least two glycidyl groups, the oxyalkylene group constituting the polyalkylene glycol chain is an oxyalkylene group preferably containing 2 or more carbon atoms, more preferably 3 or more carbon atoms, and even more preferably 4 or more carbon atoms, and preferably 12 or less carbon atoms, more preferably 8 or less carbon atoms, even more preferably 6 or less carbon atoms and most preferably an oxyalkylene group having 4 carbon atoms. These oxyalkylene groups may be linear or branched and may have a substituent group. Further, these oxyalkylene groups maybe all the same or may include different kinds of oxyalkylene groups in combination. The number of repeating oxyalkylene groups constituting the polyoxyalkylene group chain is preferably 1 or higher and preferably 100 or lower, more preferably 50 or lower, and even more preferably 30 or lower.

Specific examples of the polyglycidyl compound having a polyalkylene glycol chain and at least two glycidyl groups may include diglycidyl ethers of polyether polyols such as polyethylene ether glycol, polypropylene ether glycol, polytetramethylene ether glycol, and polypentamethylene ether glycol; diglycidyl ethers of copolyether polyols such as copoly(tetramethylene-neopentylene) ether diol, copoly(tetramethylene-2-methylbutylene) ether diol, copoly(tetramethylene-2,2-dimethylbutylene) ether diol, and copoly(tetramethylene-2,3-dimethylbutylene) ether diol; and triglycidyl ethers of aliphatic polyols such as trimethylolpropane triglycidyl ether. Among these polyglycidyl compounds, diglycidyl ethers of polyether polyols are preferable and diglycidyl ether of polytetramethylene ether glycol is particularly preferable.

According to a conventionally known method, the above-mentioned polyglycidyl compounds can be prepared by carrying out dehydration condensation, if necessary, of diols such as ethylene glycol, 1,4-butadinediol, neopentyl glycol and 1,6-hexanediol and aliphatic triols such as glycerin and trimethylolpropane and followed by reacting epichlorohydrin with the hydroxyl group at the terminal of the dehydration product.

Diglycidyl ether of polytetramethylene ether glycol is represented by the following formula (1):

### [Chemical Formula 1]

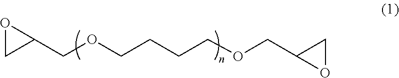

[in the above mentioned formula, n represents an integer of 1 or higher and 30 or lower]

The number average molecular weight of the polytetramethylene ether glycol is preferably 200 or higher, more preferably 250 or higher, and even more preferably 500 or higher and also preferably 2,000 or lower, more preferably 1,500 or lower, and even more preferably 1,000 or lower. Such diglycidyl ether of polytetramethylene ether glycol is obtained by a conventionally known production method. More specifically, it can be obtained by a two-step method of allowing reaction of polytetramethylene ether glycol with a number average molecular weight of preferably 200 or higher, more preferably 250 or higher, and even more preferably 500 or higher and also preferably 2,000 or lower, more preferably 1,500 or lower, and even more preferably 1,000 or lower with epichlorohydrin in the presence of acidic catalysts such as sulfuric acid, boron trifluoride ethyl ether and tin tetrachloride or in the presence of phase transfer catalysts such as quaternary ammonium salts, quaternary phosphonium salts and crown ethers to obtain a chlorohydrin ether derivative and then ring-closing the chlorohydrin ether derivative by reacting with a dehydrohalogenation agent such as sodium hydroxide. In this case, if the number average molecular weight of polytetramethylene ether glycol is too low, the flexibility of the epoxy type resin film may possibly be lowered in some cases. On the other hand, if the number average molecular weight of polytetramethylene ether glycol is too high, the diglycidyl ether of polytetramethylene ether glycol becomes solid and the handling property may possibly be worsened in some cases. Additionally, the number average molecular weight of polytetramethylene ether glycol is found by gel permeation chromatography (GPC) in terms of standard polystyrene.

The diglycidyl ether of polytetramethylene ether glycol may be synthesized by the above-mentioned production method; however commercialized products may also be used. Examples of the commercialized products of the diglycidyl ether of polytetramethylene ether glycol may include trade names such as “jER (registered trade name) YL7417” and “jER (registered trade name) YL7217” manufactured by Japan Epoxy Resin Co., Ltd.

For the purpose of adjusting refractive index and viscosity, the UV-curable epoxy resins may be mixed with bisphenol type epoxy resins and/or alicyclic epoxy resins. In this regard, epoxy resins having lower viscosity may be preferred because of their excellent handling property.

Examples of the bisphenol type epoxy resins may include bisphenol A type epoxy resins, diglycidyl ethers of bisphenol A—alkylene oxide adducts, bisphenol F type epoxy resins, diglycidyl ethers of bisphenol F—alkylene oxide adducts, bisphenol AD type epoxy resins, bisphenol S type epoxy resins, tetramethyl bisphenol A type epoxy resins, tetramethyl bisphenol F type epoxy resins, and halogenated bisphenol type epoxy resins thereof (e.g., fluorinated bisphenol type epoxy resins, chlorinated bisphenol type epoxy resins, brominated bisphenol type epoxy resins). These bisphenol type epoxy resins may be used alone, or two or more of these bisphenol type epoxy resins may also be used in combination. In these bisphenol type epoxy resins, bisphenol A type epoxy resins, bisphenol F type epoxy resins, brominated bisphenol A type epoxy resins, and brominated bisphenol F type epoxy resins may be preferred in terms of their easy availability and handling property. Commercially available products of these bisphenol type epoxy resins may include “jER (registered trade name) 828EL” (a bisphenol A type epoxy resin) and “jER (registered trade name) 5050” (a brominated bisphenol A type epoxy resin), both available from Japan Epoxy Resin Co., Ltd.

The amount of bisphenol type epoxy resin to be mixed may appropriately be adjusted so as to make an epoxy type resin film obtained from a UV-curable epoxy resin have a desired refractive index, and it is not particularly limited; however, it may preferably be 10,000 parts by mass or less, more preferably 5,000 parts by mass or less, and still more preferably 1,000 part by mass or less, relative to 100 parts by mass of the polyglycidyl compound having a polyalkylene glycol chain and at least two glycidyl groups. If the amount of bisphenol type epoxy resin to be mixed is too great, the flexibility of an epoxy type resin film obtained from a UV-curable epoxy resin maybe lowered.

Examples of the alicyclic epoxy resins may include 3,4-epoxycyclohexylmethyl-3′,4′-epoxycyclohexane carboxylate, 1,2-epoxy-vinylcyclohexene, bis(3,4-epoxycyclohexylmethyl)adipate, 1-epoxyethyl-3,4-epoxycyclohexane, limonene diepoxide, 3,4-epoxycyclohexylmethanol, dicyclopentadiene diepoxide, epoxy resins obtained by the oxidation of olefins, such as oligomer type alicyclic epoxy resin (“Epoleed (registered trade name) GT300”, “Epoleed (registered trade name) GT400”, “EHPE (registered trade name) 3150”, all available from Daicel Chemical Industries, Ltd.); epoxy resins obtained by the direct hydrogenation of aromatic epoxy resins, such as hydrogenated bisphenol A type epoxy resins, hydrogenated bisphenol F type epoxy resins, hydrogenated biphenol type epoxy resins, hydrogenated phenol novolak type epoxy resins, hydrogenated cresol novolak type epoxy resins, and hydrogenated naphthalene type epoxy resins; epoxy resins obtained by the hydrogenation of polyhydric phenols, followed by the reaction with epichlorohydrin. These alicyclic epoxy resins may be used alone, or two or more of these alicyclic epoxy resins may also be used in combination. In these alicyclic epoxy resins, 3,4-epoxycyclohexylmethyl-3′,4′-epoxycyclohexane carboxylate, hydrogenated bisphenol A type epoxy resins, and hydrogenated bisphenol F type epoxy resins may be preferred in terms of their easy availability, low viscosity, and excellent workability.

The amount of alicyclic epoxy resin to be mixed may appropriately be adjusted so as to make a UV-curable epoxy resin have desired viscosity, and it is not particularly limited; however, it may preferably be 10,000 parts by mass or less, more preferably 5,000 parts by mass or less, and still more preferably 1,000 parts by mass or less, relative to 100 parts by mass of the polyglycidyl compound having a polyalkylene glycol chain and at least two glycidyl groups. If the amount of alicyclic epoxy resin to be mixed is great, an epoxy type resin film obtained from a UV-curable epoxy resin may become hard and brittle.

For the purpose of curing UV-curable epoxy resins, the UV-curable epoxy resins are mixed with photo-cationic polymerization initiators. Examples of the photo-cationic polymerization initiators may include metal-fluoroboron complex salts and boron trifluoride complex compounds as described in U.S. Pat. No. 3,379,653; bis(perfluoroalkylsulfonyl)methane metal salts as described in U.S. Pat. No. 3,586,616; aryl diazonium compounds as described in U.S. Pat. No. 3,708,296; aromatic onium salts of group VIa elements (group VI elements) as described in U.S. Pat. No. 4,058,400; aromatic onium salts of group Va elements (group V elements) as described in U.S. Pat. No. 4,069,055; dicarbonyl chelates of from group IIIa to Va elements (group III and V elements) as described in U.S. Pat. No. 4,068,091; thiopyrylium salts as described in U.S. Pat. No. 4,139,655; group VIb elements (group XVI elements) in form of MF₆⁻0 anions (wherein M is selected from phosphorus, antimony, and arsenic) as described in U.S. Pat. No. 4,161,478; arylsulfonium complex salts as described in U.S. Pat. No. 4,231,951; aromatic iodonium complex salts and aromatic sulfonium complex salts as described in U.S. Pat. No. 4,256,828; bis[4-(diphenylsulfonio)phenyl]sulfide-bis-hexafluorometal salts (e.g., phosphates, arsenates, antimonates) as described by W. R. Watt et al. in the Journal of Polymer Science, Polymer Chemistry, vol. 22, p. 1789 (1984); mixed ligand metal salts of iron compounds; and silanol-aluminum complexes. These photo-cationic polymerization initiators maybe used alone, or two or more of these photo-cationic polymerization initiators may also be used in combination. In these photo-cationic polymerization initiators, arylsulfonium complexes, aromatic iodonium complexes or aromatic sulfonium complexes of halogen-containing complex ions, and aromatic onium salts of group II, V, and VI elements (group IIa, Va, and VIa elements) may be preferred. Some of these salts are obtained as commercially available products such as “UVI-6976” and “UVI-6992” (available from The Dow Chemical Company); “FX-512” (available from 3M Company); “UVR-6990” and “UVR-6974” (available from Union Carbide Corporation); “UVE-1014” and “UVE-1016” (available from General Electric Company); “KI-85” (available from Degussa Aktiengesellschaft), “SP-150” and “SP-170” (available from by ADEKA Corporation); and “San-Aid (registered trade name) SI-60L”, “San-Aid (registered trade name) SI-80L”, “San-Aid (registered trade name) SI-100L”, “San-Aid (registered trade name) SI-110L”, and “San-Aid (registered trade name) SI-180L” (available from Sanshin Chemical Industry Co., Ltd.).

Further, in these photo-cationic polymerization initiators, onium salts may be preferred, and diazonium salts, iodonium salts, sulfonium salts, and phosphonium salts may particularly be preferred, because they are excellent in handling property and balance between the latent property and the curability.

The amount of photo-cationic polymerization initiator to be mixed may appropriately be adjusted depending on the amount of epoxy resin components to be cured, and it is not particularly limited; however, it may preferably be 0.1 parts by mass or greater, more preferably 0.5 parts by mass or greater, and still more preferably 1 part by mass or greater, and preferably 10 parts by mass or smaller, more preferably 8 parts by mass or smaller, and still more preferably 5 parts by mass or smaller, relative to 100 parts by mass of the total amount of epoxy resin components.

The UV-curable type epoxy resin can be adjusted to have a viscosity in the range of 10 mPa·s or higher and 100,000 mPa·s or lower at a temperature of 23° C. by properly selecting the molecular weights of the polyglycidyl compound having a polyalkylene glycol chain and at least two glycidyl groups, which is a raw material, and a bisphenol type epoxy resin, alicyclic epoxy resin and the like to be blended if necessary, without using a solvent.

Since the UV-curable type epoxy resin is in a liquid state at ambient temperature, after a second stamp is placed on a substrate and a proper amount of the epoxy resin is injected and filled into a space therebetween; or after a proper amount of the epoxy resin is dropped to the substrate and the second stamp is placed thereon; or after the epoxy resin is injected and filled into a core groove; or after the epoxy resin is injected and filled into spacer grooves and applied to a lower cladding layer in a manner of embedding a core layer therein, ultraviolet rays having an integrated light irradiation quantity (exposure energy) of, for example, 0.01 J/cm² or higher and 10 J/cm² or lower are radiated to cure the epoxy resin and accordingly, a cured epoxy type resin film constituting a lower cladding layer, a core layer, or an upper cladding layer is obtained.

### <Stamp for Use in Optical Waveguide Production Process>

The stamp for use in the optical waveguide production process of the present invention comprises a convex portion or a concave portion corresponding to a core groove and convex portions or concave portions corresponding to spacer grooves formed substantially in parallel with intervals in both sides of the convex portion or the concave portion corresponding to the core groove.

As described above, in the production process of the present invention, a lower cladding layer having a core groove and spacer grooves formed substantially in parallel with intervals in both sides of the core groove is formed by employing soft lithography. A typical example of a master stamp (a first stamp) to be used in this case is indicated in FIG. 1(a) with reference numeral 5 and a typical example of a stamp (a second stamp) made of a resin produced from this master stamp (the first stamp) is indicated in FIG. 1(b) with reference numeral 6.

As shown in FIG. 1(a), the first stamp 5 has a concave portion 7 corresponding to a core groove and concave portions 8 corresponding to spacer grooves to be formed substantially in parallel with intervals in both sides of the concave portion corresponding to the core groove. Examples of a material constituting the first stamp 5 may include organic materials (e.g., permanent resist, poly (methyl methacrylate) and epoxy type resins) and inorganic materials (e.g., metals or alloys such as phosphor bronze and quartz glass). A method for producing the first stamp 5 may include, for example, photolithography, cutting and the like in the case of organic materials and, for example, cutting, etching, air-blast, laminating and the like in the case of inorganic materials. Among these materials and production methods, taking into consideration durability as a master stamp (a first stamp), inorganic materials and cutting are particularly preferable.

In the first stamp 5, a ratio (y/x) of the depth (y) of the concave portion 8 corresponding to the spacer groove to the interval (x) between the concave portion 7 corresponding to the core groove and the concave portion 8 corresponding to the spacer groove is preferably 1/10 or higher and 3/1 or lower.

In this connection, although only one concave portion 7 corresponding to the core groove is formed in the first stamp 5 indicated in FIG. 1(a), two or more concave portions corresponding to the core grooves may be formed in accordance with the applications of the optical waveguide. Further, the concave portion 7 corresponding to the core groove is formed in a line extending along the perpendicular direction to the paper face; however it may be formed in a prescribed pattern depending on the applications of the optical waveguide. Furthermore, the first stamp 5 indicated in FIG. 1(a) is configured such that one optical waveguide is manufactured; however it may be configured such that a plurality of optical waveguides are manufactured.

In addition, although not illustrated in FIG. 1(a), a concave portion corresponding to an optical fiber fixation groove may be formed in series (in the perpendicular direction on the paper face) to the concave portion 7 corresponding to the core groove in the first stamp 5 in accordance with the applications of the optical waveguide. Further, at the time of injecting and filling a core material in the core groove, in order to prevent entering the core material into the optical fiber fixation groove, it is preferable to form a convex portion corresponding to the weir between the concave portion 7 corresponding to the core groove and the concave portion corresponding to the optical fiber fixation groove. Moreover, it is also preferable that the upper end face portion of the concave portion 7 corresponding to the core groove (opening portion of the concave portion 7) is lower than the upper end face portion of the concave portion corresponding to the optical fiber fixation groove.

As indicated in FIG. 1(b), a second stamp 6 has a convex portion 9 corresponding to a core groove and convex portions (spacers) 10 corresponding to spacer grooves to be formed in parallel with intervals in both sides of the convex portion corresponding to the core groove. A material constituting the second stamp 6 is not particularly limited so long as it can be formed by using the first stamp 5 and examples thereof may include hardening resins such as UV-curable (or light-curable) resins and thermosetting resins (or two component curable resins) and also thermoplastic resins. For example, when hardening resins are used, the second stamp 6 can be produced by pouring a hardening resin to fill the concave portions formed in the first stamp 5, followed by curing the resin. When thermoplastic resins are used, the second stamp 6 can be produced by placing a thermoplastic resin made to be in fluidized state or melted state by heating on the side where the concave portions of the first stamp 5 are formed or by pouring a thermoplastic resin to fill the concave portions of the first stamp 5, followed by, if necessary, cooling under pressure.

In the materials constituting the second stamp 6, silicone materials may particularly be preferred because the property of separating a lower cladding layer to be formed can be improved. In the silicone materials, there may be preferred curable silicone materials such as curable silicone type rubber oligomers or monomers to become silicone type rubber or silicone type resins after curing, and curable silicone type resin oligomers or monomers, and curable polysiloxanes may particularly be preferred. As the curable silicone materials, those which are called “liquid silicones” are usually used, and those of the two-component mixture type to be used in combination with a curing agent may be preferred because of their excellent property of separating a lower cladding layer to be formed as well as their excellent mechanical strength. Further, if curable silicone materials with low viscosity are used, they are excellent in processability for removing air bubbles entrapped at the time of production of the stamp and they can achieve precise forming of a transfer pattern. Further, curable polysiloxanes may be of either the mono-component curable type or the two-component curable type, and may also be of either the heat-curable type or the room temperature-curable type.

Specific examples of the curable silicone materials may include those which contain alkylsiloxanes, and/or alkenylsiloxanes, and/or alkylalkenylsiloxanes, and/or polyalkylhydrogensiloxanes. Those of the two-component mixture type, containing alkylalkenylsiloxanes and polyalkylhydrogensiloxanes, and having low viscosity and being curable at room temperature, may particularly be preferred in terms of separation property and curability.

In the second stamp 6, a ratio (y/x) of the bight (y) of the convex portion 10 corresponding to the spacer groove to the interval (x) between the convex portion 9 corresponding to the core groove and the convex portion 10 corresponding to the spacer groove is preferably 1/10 or higher and 3/1 or lower.

In the second stamp 6 as indicated in FIG. 1(b), only one convex portion 9 corresponding to a core groove is formed; however, two or more convex portions corresponding to two or more core grooves may be formed depending on the applications of the optical waveguide. Further, the convex portion 9 corresponding to a core groove is formed in a line extending along the perpendicular direction to the paper face; however, it may be formed in a prescribed pattern depending on the applications of the optical waveguide. Furthermore, the second stamp 6 as indicated in FIG. 1(b) is formed to produce only one optical waveguide; however, it may be formed to produce two or more optical waveguide.

In addition, although not illustrated in FIG. 1(b), a convex portion corresponding to an optical fiber fixation groove may be formed in series (in the perpendicular direction on the paper face) to the convex portion 9 corresponding to the core groove in the second stamp 6 in accordance with the applications of the optical waveguide. Further, at the time of injecting and filling a core material into the core groove, in order to prevent entering the core material into the optical fiber fixation groove, it is preferable to form a convex portion corresponding to the weir between the convex portion 9 corresponding to the core groove and the convex portion corresponding to the optical fiber fixation groove. Moreover, it is also preferable that the lower end face portion of the convex portion 9 corresponding to the core groove (top portion of the convex portion 9) is lower than the lower end face portion of the concave portion corresponding to the optical fiber fixation groove.

The reason for forming a core groove and spacer grooves formed substantially in parallel with intervals in both sides of the core groove in the lower cladding layer with a second stamp produced from a first stamp is as follows. When a core groove and spacer grooves formed substantially in parallel with intervals in both sides of the core groove are formed in the lower cladding layer, if the lower cladding layer is formed with a first stamp (male stamp) as a master stamp having convex portions corresponding to the respective grooves, forming failure occurs to cause a decrease in size precision in the case where the property of separating the lower cladding layer from the first stamp (male stamp) is deteriorated. Further, even if the property of separating the lower cladding layer from the first stamp (male stamp) is improved by applying a release agent to the first stamp (male stamp), there is another problem that the removal of the release agent becomes difficult. Therefore, for the purpose of forming a lower cladding layer, it is advantageous to produce and use a second stamp (i.e., a male stamp) made of a resin with a first stamp as a master stamp (i.e., a female stamp).

When a second stamp is made of a transparent flexible material such as silicone type rubber, even in the case of a groove having a narrow width and depth just like a spacer groove, such a groove can clearly be transferred regardless of the hardness of a cladding material constituting a lower cladding layer. Therefore, there are advantages that the selection of a cladding material constituting a lower cladding layer becomes wide and that when UV-curable (or light-curable) resins are used, since the second stamp can transmit ultraviolet rays (or light) at the time of curing the resins with ultraviolet rays (or light), a material constituting abase substrate to form the lower cladding layer is not required to be limited to a transparent material.

If the stamp of the present invention is used, an optical waveguide having a substantially uniform thickness of a lower cladding layer in the portion positioned in the lower side of a core layer and having extremely low waveguide loss can be produced in a simple and easy manner.

### EXAMPLES

The present invention will be described below in more detail by way of Examples, but the present invention is not limited to the following Examples. The present invention can be put into practice after appropriate modifications or variations within a range meeting the gists described above and later, all of which are included in the technical scope of the present invention.

First, preparation of UV-curable type epoxy resins used as a cladding material and a core material in Examples and Comparative Examples will be described.

### <Preparation of UV-Curable Type Epoxy Resin (1)>

UV-curable type epoxy resin (1) to be used as a cladding material was prepared by mixing 48 parts by mass of diglycidyl ether of polytetramethylene glycol (trade name, “jER (registered trade name) YL7417” manufactured by Japan Epoxy Resin Co., Ltd.; number average molecular weight of 700 to 800), 30 parts by mass of ε-caprolactone modified-3,4-epoxycyclohexylmethyl-3′,4′-epoxycyclohexanecarboxyl ate (trade name, “Celloxide (registered trade name) 2081”, manufactured by Daicel Chemical Industries, Ltd.), 15 parts by mass of a bisphenol A type epoxy resin (trade name, “jER (registered trade name) 828EL” manufactured by Japan Epoxy Resin Co., Ltd.), and 4 parts by mass of triarylsulfonium hexafluorophosphate (trade name, “UVI-6992”, manufactured by The Dow Chemical Company), as a photopolymerization initiator, while using a rotational-revolutional mixer (trade name, “Awatori Rentaro (registered trade name)”, manufactured by THINKY Corporation).

### <Preparation of UV-Curable Type Epoxy Resin (2)>

UV-curable type epoxy resin (2) to be used as a core material was prepared by mixing 9 parts by mass of diglycidyl ether of polytetramethylene glycol (trade name, “jER (registered trade name) YL7417” manufactured by Japan Epoxy Resin Co., Ltd.; number average molecular weight of 700 to 800), 43.5 parts by mass of a bisphenol A type epoxy resin (trade name, “jER (registered trade name) 828EL” manufactured by Japan Epoxy Resin Co., Ltd.), 43.5 parts by mass of a brominated bisphenol A type epoxy resin (trade name, “jER (registered trade name) 5050” manufactured by Japan Epoxy Resin Co., Ltd.), and 4 parts by mass of triarylsulfonium hexafluorophosphate (trade name, “UVI-6992”, manufactured by The Dow Chemical Company), as a photopolymerization initiator, while using a rotational-revolutional mixer (trade name, “Awatori Rentaro (registered trade name)”, manufactured by THINKY Corporation).

### <Preparation of UV-Curable Type Epoxy Resin (3)>

UV-curable type epoxy resin (3) to be used as a cladding material was prepared by mixing 18 parts by mass of diglycidyl ether of polytetramethylene glycol (trade name, “jER (registered trade name) YL7417” manufactured by Japan Epoxy Resin Co., Ltd.; number average molecular weight of 700 to 800), 78 parts by mass of (3′,4′-epoxycyclohexane)methyl-3,4-epoxycyclohexanecarboxylate (trade name, “Celloxide (registered trade name) 2021P”, manufactured by Daicel Chemical Industries, Ltd.), and 4 parts by mass of triarylsulfonium hexafluorophosphate, (trade name, “UVI-6992”, manufactured by The Dow Chemical Company), as a photopolymerization initiator, while using a rotational-revolutional mixer (trade name, “Awatori Rentaro (registered trade name)”, manufactured by THINKY Corporation).

### <Preparation of UV-Curable Type Epoxy Resin (4)>

UV-curable type epoxy resin (4) to be used as a core material was prepared by mixing 15 parts by mass of diglycidyl ether of polytetramethylene glycol (trade name, “jER (registered trade name) YL7417” manufactured by Japan Epoxy Resin Co., Ltd.; number average molecular weight of 700 to 800), 81 parts by mass of a bisphenol A type epoxy resin (trade name, “jER (registered trade name) 828EL” manufactured by Japan Epoxy Resin Co., Ltd.), and 4 parts by mass of triarylsulfonium hexafluorophosphate (trade name, “UVI-6992”, manufactured by The Dow Chemical Company), as a photopolymerization initiator, while using a rotational-revolutional mixer (trade name, “Awatori Rentaro (registered trade name)”, manufactured by THINKY Corporation).

Next, Examples and Comparative Examples of actually producing optical waveguides will be described.

### <Production of Optical Waveguide>

### Example 1

A flexible optical waveguide was produced in this Example.

1) A first stamp (a female stamp) as shown in FIG. 1(a) was produced by cutting the surface of a phosphor bronze plate (thickness of 10 mm) to form a concave portion having a width of 50 μm and a depth of 50 μm corresponding to a core groove and concave portions having a width of 1.5 mm and a depth of 75 μm corresponding to spacer grooves to be formed substantially in parallel with intervals of 100 μm in both sides of the concave portion corresponding to the core groove. In FIG. 1(a), the concave portions 8 corresponding to the spacer grooves are illustrated with their widths narrow as compared with their depths because of the drawing space.

2) A second stamp (a male stamp) made of silicone type rubber was produced by placing the first stamp on a glass substrate (thickness of 2 mm) with a space, and without introducing air bubbles, injecting and filling two-component curable silicone type rubber (trade mane, “SILPOT 184”, manufactured by Dow Corning Toray Co., Ltd.) into the space between the glass substrate and the first stamp, and allowing it to stand still at room temperature for 24 hours to cure the silicone type rubber. As shown in FIG. 1(b), the obtained second stamp had a convex portion corresponding to the core groove and convex portions corresponding to the spacer grooves formed substantially in parallel with intervals in both sides of the convex portion corresponding to the core groove. In addition, in FIG. 1(b), convex portions 10 corresponding to spacer grooves are illustrated with their widths narrow as compared with their depths because of the drawing space.

3) After a proper amount of UV-curable type epoxy resin (1), as a cladding material, was dropped to a polyimide film (trade name, “Kapton (registered trade name) H type”, manufactured by Du Pont Toray Co., Ltd.; thickness of 25 μm), as a film substrate, the second stamp was set closer to the film substrate in a manner of bringing the convex portions (spacers) corresponding to the spacer grooves into contact with the film substrate on a stage provided with parallelism. Before the spacers of the second stamp were brought into contact with the film substrate, the second stamp was once stopped and defoaming was carried out by vacuum evacuation to remove foams from the cladding material.

Next, as shown in FIG. 1(c), the second stamp was pushed against the film substrate in a manner of closely contacting the spacers of the second stamp to the film substrate. In this condition, UV radiation was carried out from the second stamp side to cure the cladding material and thereafter, the second stamp was removed to form a lower cladding layer having a core groove and spacer grooves formed in parallel with intervals in both sides of the core groove on the film substrate as shown in FIG. 1(d). The thickness of the lower cladding layer was equal to the depth of the spacer groove and it was 75 μm (the thickness of the lower side of the core groove was 25 μm). In addition, in FIG. 1(c), convex portions 10 corresponding to spacer grooves are illustrated with their widths narrow as compared with their depths because of the drawing space. Further, in FIG. 1(d), spacer grooves 12 are illustrated with their widths narrow as compared with their depths because of the drawing space. In this case, the refractive index of the lower cladding layer measured by a prism coupler (trade name, “SPA-4000”, manufactured by Cylon Technology Inc.) was 1.50 at a wavelength of 830 nm.

4) The film substrate on which the lower cladding layer was formed was placed on a hot plate, and UV-curable type epoxy resin (2), as a core material, was dropped to both ends of the core groove formed on the lower cladding layer to fill the entire core groove with the core material by utilizing the capillary phenomenon. On completion of the filling of the core material, heating was stopped and UV radiation was carried out to cure the core material and thus a core layer with a width of 50 μm and a thickness of 50 μm was formed in the core groove as shown in FIG. 1(e). Additionally, in FIG. 1(e), spacer grooves 12 are illustrated with their widths narrow as compared with their depths because of the drawing space. In this case, the refractive index of the core layer measured by a prism coupler (trade name, “SPA-4000”, manufactured by Cylon Technology Inc.) was 1.58 at a wavelength of 830 nm.

5) A proper amount of UV-curable type epoxy resin (1), as a cladding material, was dropped to the lower cladding layer on which a core layer was formed and a glass substrate subjected to release treatment was placed thereon. Next, at the time when foams were completely removed by carrying out defoaming by vacuum evacuation before the space between the lower cladding layer and the glass substrate became a desired value, then the glass substrate was closely stuck until the space became the desired value. In this condition, UV radiation was carried out from the glass substrate side to cure the cladding material and form an upper cladding layer with a thickness of 25 μm and thus a flexible optical waveguide as shown in FIG. 1(f) was obtained. Additionally, in FIG. 1(f), the cured material of the cladding material embedding the spacer grooves 12 therein was illustrate with its width narrow as compared with its thickness because of the drawing space. In this case, the refractive index of the upper cladding layer measured by a prism coupler (trade name, “SPA-4000”, manufactured by Cylon Technology Inc.) was 1.50 at a wavelength of 830 nm.

In steps 3) to 5), curing of the UV-curable type epoxy resins was carried out using an exposure apparatus employing a high pressure mercury lamp (trade name, “MA-60 F”, manufactured by Mikasa Co., Ltd.) as a light source under the condition of illumination intensity of 10 mW/cm² for 15 minutes, that is, exposure energy of 9 J/cm².

6) With respect to the obtained flexible optical waveguide, the intensity of light transmitted in the core layer was measured by leading light with a wavelength of 850 nm to one end of the core layer by using an optical fiber connected to a LED light source with a wavelength of 850 nm in the other end of the optical fiber and at the same time bringing an optical fiber connected to an actinometer into contact with the other end of the core layer to find that the waveguide loss was as extremely low as 0.1 dB/cm.

Further, even if being folded at ±90° in a radius of 1 mm, the flexible optical waveguide showed good appearance without being accompanied with any folding lines or any cracks.

### Comparative Example 1

A flexible optical waveguide was produced in this Comparative Example.

It was tried to produce a flexible optical waveguide in the same manner as in Example 1, except that a first stamp (a female stamp) having a concave portion corresponding to the core groove but no concave portions corresponding to the spacer grooves to be formed substantially in parallel to intervals in both sides of the concave portion corresponding to the core groove was used in Example 1; however a second stamp (a male stamp) slacked and thus the thickness of the lower cladding layer in the portion positioned in the lower side of the core groove could not be controlled and injection of the core material in the core groove based on the capillary phenomenon was difficult. Further, although the steps up to formation of an upper cladding layer were carried out while taking time, the thicknesses of the respective layers were uneven and the thickness of the flexible optical waveguide was uneven as a whole.

When the waveguide loss was measured for the obtained flexible optical waveguide in the same manner as in Example 1, it was as high as 0.5 dB/cm.

When the optical waveguide was folded at ±90° in a radius of 1 mm, no crack was formed, but folding lines were formed.

### Example 2

A flexible optical waveguide substrate having an optical fiber fixation groove was produced in this Example.

1) A first stamp (a female stamp) was produced by cutting the surface of a phosphor bronze plate (thickness of 10 mm) to form a concave portion having a width of 50 μm and a depth of 50 μm corresponding to a core groove, concave portions having a width of 1.5 mm and a depth of 87.5 μm corresponding to spacer grooves to be formed substantially in parallel with intervals of 0.55 μm in both sides of the concave portion corresponding to the core groove, a concave portion having a width of 130 μm and a depth of 112.5 μm corresponding to an optical fiber fixation groove, and a convex portions having a thickness of 50 μm and a height of 112.5 μm corresponding to the weir between the concave portion corresponding to the core groove and the concave portion corresponding to the optical fiber fixation groove.

2) A second stamp (a male stamp) made of silicone type rubber was produced by placing the first stamp on a glass substrate (thickness of 2 mm) with a space, and without introducing air bubbles, injecting and filling two-component curable silicone type rubber (trade mane, “SILPOT 184”, manufactured by Dow Corning Toray Co., Ltd.) into the space between the glass substrate and the first stamp, and allowing it to stand still at room temperature for 24 hours to cure the silicone type rubber. The obtained second stamp had a convex portion corresponding to the core groove, convex portions corresponding to the spacer grooves formed substantially in parallel with intervals in both sides of the convex portion corresponding to the core groove, and a convex portion corresponding to the optical fiber fixation groove as well as a concave portion corresponding to the weir between the convex portion corresponding to the core groove and the convex portion corresponding to the optical fiber fixation groove.

3) After a proper amount of UV-curable type epoxy resin (3), as a cladding material, was dropped to a polyimide film (trade name, “Kapton (registered trade name) H type”, manufactured by Du Pont Toray Co., Ltd.; thickness of 25 μm), as a film substrate, the second stamp was set closer to the film substrate in a manner of bringing the convex portions (spacers) corresponding to the spacer grooves into contact with the film substrate on a stage provided with parallelism. Before the spacers of the second stamp were brought into contact with the film substrate, the second stamp was once stopped and defoaming was carried out by vacuum evacuation to remove foams from the cladding material.

Next, the second stamp was pushed against the film substrate in a manner of closely contacting the spacers of the second stamp to the film substrate. In this condition, UV radiation was carried out from the second stamp side to cure the cladding material and thereafter, the second stamp was removed to form a lower cladding layer having a core groove, spacer grooves formed substantially in parallel with intervals in both sides of the core groove and an optical fiber fixation groove as well as a weir formed between the core groove and the optical fiber fixation groove on the film substrate. The thickness of the lower cladding layer was equal to the depth of the spacer groove and it was 87.5 μm (the thickness of the lower side of the core groove was 37.5 μm). In this case, the refractive index of the lower cladding layer measured by a prism coupler (trade name, “SPA-4000”, manufactured by Cylon Technology Inc.) was 1.51 at a wavelength of 830 nm.

4) The film substrate on which the lower cladding layer was formed was placed on a hot plate, and UV-curable type epoxy resin (4), as a core material, was dropped to both ends of the core groove formed on the lower cladding layer to fill the entire core groove with the core material by utilizing the capillary phenomenon. On completion of the filling of the core material, heating was stopped and UV radiation was carried out to cure the core material and thus a core layer with a width of 50 μm and a thickness of 50 μm was formed in the core groove. In this case, the refractive index of the core layer measured by a prism coupler (trade name, “SPA-4000”, manufactured by Cylon Technology Inc.) was 1.56 at a wavelength of 830 nm.

5) A proper amount of UV-curable type epoxy resin (3), as a cladding material, was dropped to the lower cladding layer on which a core layer was formed and a glass substrate subjected to release treatment was placed thereon. The glass substrate to be used in this case was a masked glass substrate so as to keep the optical fiber fixation groove from radiation with ultraviolet rays. Next, at the time when foams were completely removed by carrying out defoaming by vacuum evacuation before the space between the lower cladding layer and the glass substrate became a desired value, the glass substrate was closely stuck until the space became the desired value. In this condition, after UV radiation was carried out from the glass substrate side to cure the cladding material and form an upper cladding layer with a thickness of 25 μm, the uncured portions were removed with acetone and the obtained product was washed with ultrapure water and dried to obtain an optical waveguide substrate having an optical fiber fixation groove. In this case, the refractive index of the upper cladding layer measured by a prism coupler (trade name, “SPA-4000”, manufactured by Cylon Technology Inc.) was 1.51 at a wavelength of 830 nm.

In steps 3) to 5), curing of the UV-curable type epoxy resins was carried out using an exposure apparatus employing a high pressure mercury lamp (trade name, “MA-60 F”, manufactured by Mikasa Co., Ltd.) as a light source under the condition of illumination intensity of 10 mW/cm² for 5 minutes, that is, exposure energy of 3 J/cm².

6) The core side of a GI optical fiber (outer diameter of 125 μm, core diameter of 50 μm, length of 1 m, one end portion thereof was the core and the other end portion thereof was connected with an LED light source with a wavelength of 850 nm) was inserted into the optical fiber fixation groove of the obtained optical waveguide substrate having an optical fiber fixation groove. When light with a wavelength of 850 nm was led to one end of the core layer and at the same time, the other end of the core layer was brought into contact with an optical fiber connected to an actinometer to measure the intensity of the light transmitted in the core layer, the waveguide loss was as extremely low as 0.1 dB/cm.

### Comparative Example 2

An optical waveguide substrate having an optical fiber fixation groove was produced in this Comparative Example.

It was tried to produce an optical waveguide substrate having an optical fiber fixation groove in the same manner as in Example 2, except that a first stamp (a female stamp) having a concave portion corresponding to the core groove and a concave portion corresponding to the optical fiber fixation groove and a convex portion corresponding to the weir but no concave portions corresponding to the spacer grooves to be formed substantially in parallel to intervals in both sides of the concave portion corresponding to the core groove was used; however a second stamp (a male stamp) slacked and thus the thickness of the lower cladding layer in the portion positioned in the lower side of the core groove could not be controlled and injection of the core material in the core groove based on the capillary phenomenon was difficult. Further, although the steps up to formation of an upper cladding layer were carried out while taking time, the thicknesses of the respective layers were uneven and the thickness of the obtained optical waveguide substrate having an optical fiber fixation groove was not uniform as a whole.

When an optical fiber was inserted into the optical fiber fixation groove of the obtained optical waveguide substrate having an optical fiber fixation groove, the positioning control of the optical fiber and the core layer of the optical waveguide was insufficient and therefore optical axes were shifted. Further, when the waveguide loss was measured for the obtained optical waveguide substrate having an optical fiber fixation groove in the same manner as in Example 2, it was as high as 1 dB/cm.

### <Evaluation>

As described above, with respect to the flexible optical waveguide of Example 1 and the optical waveguide substrate having an optical fiber fixation groove of Example 2, since the male stamp having a convex portion corresponding to the core groove and convex portions corresponding to the spacer grooves formed substantially in parallel with intervals in both sides of the convex portion corresponding to the core groove was employed to form the lower cladding layer having the core groove and the spacer grooves formed substantially in parallel with intervals in both sides of the core groove on a film substrate, due to the existence of the convex portions (spacers) corresponding to the spacer grooves, the film substrate or the male stamp was supported and held substantially in parallel without slacking and thus the thickness of the lower cladding layer could be easily controlled in the portion positioned in the lower side of the core layer and as a result, the flexible optical waveguide and the optical waveguide substrate having an optical fiber fixation groove indicate an extremely low waveguide loss. Moreover, since the flexible optical waveguide of Example 1 had the lower cladding layer, the core layer, and the upper cladding layer with uniform thicknesses, even if being folded at ±90° in a radius of 1 mm, the flexible optical waveguide had good appearance without being accompanied with any folding lines or any cracks.

On the other hand, with respective to the flexible optical waveguide of Comparative Example 1 and the optical waveguide substrate having an optical fiber fixation groove of Comparative Example 2, since the lower cladding layer having a core groove was formed on a film substrate by using the male stamp having a convex portion corresponding to the core groove but no convex portions corresponding to the spacer grooves formed substantially in parallel to intervals in both sides of the convex portion corresponding to the core groove; the male stamp slacked and thus the thickness of the lower cladding layer in the portion positioned in the lower side of the core groove could not be controlled, resulting in a significant waveguide loss. Moreover, since the flexible optical waveguide of Comparative Example 1 had uneven thicknesses of the lower cladding layer, the core layer, and the upper cladding layer, when it was folded at ±90° in a radius of 1 mm, no crack was formed but folding lines were formed.

Consequently, it can be understood that, in the optical waveguide production process, if the lower cladding layer having the core groove and the spacer grooves formed substantially in parallel with intervals in both sides of the core groove was formed on a film substrate by employing the male stamp having a convex portion corresponding to the core groove and convex portions corresponding to the spacer grooves formed substantially in parallel with intervals in both sides of the convex portion corresponding to the core groove but not the male stamp having only the convex portion corresponding to the core groove, even in a case where such a substrate with low rigidity such as a film substrate was employed or the male stamp was made of a material with low rigidity, the thickness of the lower cladding layer could be easily controlled in the portion positioned in the lower side of the core layer and thus the optical waveguide with extremely low waveguide loss and high performance is obtained easily.

### INDUSTRIAL APPLICABILITY

Since the optical waveguide production process and stamp for use in the method of the present invention make it possible to easily produce an optical waveguide having substantially uniform and controlled thickness of a lower cladding layer in the portion positioned in the lower side of a core layer and extremely low waveguide loss even if a substrate with low rigidity such as a film substrate is employed and also even if a flexible material such as silicone type rubber is used for constituting the stamp, the production cost can be considerably reduced in the case of manufacturing a high performance optical waveguide. Accordingly, the present invention makes a great contribution to various optics related fields and electronic equipment fields, in which the applications of optical waveguide with extremely low waveguide loss and high performance are highly expected.

The present application is claiming priority of Japanese patent application No. 2008-147315, and the whole contents of the Japanese patent application No. 2008-147315 are hereby incorporated by the reference.

### EXPLANATION OF SYMBOLS

1 Substrate

2 Lower cladding layer

3 Core layer

4 Upper cladding layer

5 First stamp (female stamp)

6 Second stamp (male stamp)

7 Concave portion corresponding to a core groove

8 Concave portion corresponding to a spacer groove

9 Convex portion corresponding to a core groove

10 Convex portion corresponding to a spacer groove (spacer)

11 Core groove

12 Spacer groove

1. A process for producing an optical waveguide comprising steps of:
forming a lower cladding layer having a core groove and spacer grooves formed substantially in parallel with intervals in both sides of the core groove on a substrate by using a second stamp having a convex portion corresponding to the core groove and convex portions corresponding to spacer grooves formed substantially in parallel with intervals in both sides of convex portion corresponding to the core groove;
forming a core layer by injecting and filling a core material into the core groove and followed by curing the core material; and
forming an upper cladding layer by injecting and filling a cladding material into the spacer grooves and applying the cladding material to the lower cladding layer in a manner of embedding the core layer therein and followed by curing the cladding material.

2. The process according to claim 1, wherein the step of forming the lower cladding layer includes a step of dropping a cladding material to the substrate, placing the second stamp on the substrate, curing the cladding material, and removing the second stamp.

3. The process for producing the optical waveguide according to claim 1, wherein the substrate is a film substrate.

4. The process according to claim 1, wherein a ratio (y/x) of the depth (y) of the spacer groove to the interval (x) between the core groove and the spacer grove is 1/10 or higher and 3/1 or lower.

5. The process according to claim 1, wherein the cladding material is cured after dropping the cladding material and placing the second stamp on the substrate, and pushing the second stamp against the substrate to closely contact the convex portions corresponding to the spacer grooves.

6. The process according to claim 1, wherein the second stamp is prepared using a first stamp having a concave portion corresponding to the core groove and concave portions corresponding to the spacer grooves.

7. The process according to claim 1, wherein the cladding material and/or the core material is UV-curable epoxy resin.

8. A stamp used in a process for producing an optical wave guide, in which the process includes a step of forming a lower cladding layer having a core groove and spacer grooves formed substantially in parallel with intervals in both sides of the core groove on a substrate by using a second stamp having a convex portion corresponding to the core groove and convex portions corresponding to spacer grooves formed substantially in parallel with intervals in both sides of the convex portion corresponding to the core groove, wherein the stamp comprises a convex portion corresponding to the core groove and convex portions corresponding to the spacer grooves formed substantially in parallel with intervals in both sides of the convex portion corresponding to the core groove.

9. The stamp according to claim 8, wherein a ratio (y/x) of the height (y) of the convex portion corresponding to the spacer groove to the interval (x) between the convex portion corresponding to the core groove and the convex portion corresponding to spacer grove is 1/10 or higher and 3/1 or lower.

10. A stamp used in a process for producing an optical wave guide, in which the process includes a step of forming a lower cladding layer having a core groove and spacer grooves formed substantially in parallel with intervals in both sides of the core groove on a substrate by using a second stamp having a convex portion corresponding to the core groove and convex portions corresponding to spacer grooves formed substantially in parallel with intervals in both sides of the convex portion corresponding to the core groove, wherein the stamp comprises a concave portion corresponding to the core groove and concave portions corresponding to the spacer grooves formed substantially in parallel with intervals in both sides of the concave portion corresponding to the core groove.

11. The stamp according to claim 10, wherein a ratio (y/x) of the depth (y) of the concave portion corresponding to the spacer groove to the interval (x) between the concave portion corresponding to the core groove and the concave portion corresponding to spacer grove is 1/10 or higher and 3/1 or lower.
